(19) United States
(12) Patent Application Publication
(10) Pub. No.: US 2026/0084674 A1
(43) Pub. Date: Mar. 26, 2026

(54) ACTIVE BACKDRIVE ASSEMBLY FOR ELECTROMECHANICAL BRAKE SYSTEM

(71) Applicant: HL MANDO CORPORATION, Gyeonggi-do (KR)

(72) Inventor: Suresh KODURI, Novi, MI (US)

(21) Appl. No.: 19/321,507

(22) Filed: Sep. 8, 2025

Related U.S. Application Data
(60) Provisional application No. 63/697,060, filed on Sep. 20, 2024.

(51) Int. Cl. B60T 13/74; F16D 65/18; F16D 121/14; F16D 121/24; F16D 123/00; F16D 125/40; F16D 125/44; F16D 127/02

(52) U.S. Cl. CPC B60T 13/746; F16D 65/18; F16D 2121/14; F16D 2121/24; F16D 2123/00; F16D 2125/40; F16D 2125/44; F16D 2127/02

(57) ABSTRACT

An electromechanical brake (EMB) system is provided. The EMB system comprises: a brake rotor configured to be rotatable with a wheel of a vehicle; a brake pad assembly configured to be engageable with the brake rotor; an actuator assembly including an electric motor configured to actuate a translatable part and a rotatable part to mechanically move the brake pad assembly toward or away from the brake rotor; and an active backdrive assembly configured to release the EMB system from an on-brake state to an off-brake state without using any electrical power when the EMB system is in a powerless state following a braking operation of the vehicle.

### CROSS REFERENCE TO PARENT APPLICATIONS

This application claims the benefit of U.S. patent application Ser. No. 63/697,060 filed on Sep. 20, 2024, entitled “ELECTRO-MECHANICAL BRAKE SYSTEM WITH ACTIVE BACKDRIVE”, the entirety of which is incorporated herein by reference.

### BACKGROUND

Various embodiments of the present disclosure generally relate to an electromechanical brake (EMB) system (also referred to herein as an “EMB assembly”) and more particularly to an inductive position sensor of the EMB system.

A brake system for a motor vehicle, and in particular an automotive vehicle, functionally reduces the speed of the vehicle or maintains the vehicle in a rest position. Various types of brake systems are commonly used in automotive vehicles, including hydraulic, anti-lock or “ABS,” EMB systems, and electric or “brake by wire.”

For example, in a hydraulic brake system, the hydraulic fluid transfers energy from a brake pedal to a brake pad for slowing down or stopping rotation of a wheel of the vehicle. In an electric brake system, the application and release of the brake is controlled by an electric caliper via electrical signal. The electric brake system typically includes an electric actuator connected to a brake caliper either by a cable, as the drum in head, or directly attached to the brake caliper. The electric actuator converts electrical power to rotational mechanical output power for moving the cable or drive screw and applying the brakes.

Electric brake systems may also include an electric motor that controls movement of the electric actuator and sensors for measuring a position of the electric motor.

### SUMMARY

The features and advantages of the present disclosure will be more readily understood and apparent from the following detailed description, which should be read in conjunction with the accompanying drawings, and from the claims which are appended to the end of the detailed description.

According to various embodiments of the present disclosure, an electromechanical brake (EMB) assembly may comprise: a brake rotor configured to be rotatable with a wheel of a vehicle; a brake pad assembly configured to be engageable with the brake rotor; an actuator assembly comprising an electric motor configured to actuate a translatable part and a rotatable part to mechanically move the brake pad assembly toward or away from the brake rotor; and an active backdrive assembly configured to release the EMB system from an on-brake state to an off-brake state without using any electrical power when the EMB system is in a powerless state following a braking operation of the vehicle.

The translatable part is inserted through and partially surrounded by the rotatable part, and the active backdrive assembly is disposed on the rotatable part.

The translatable part is attached to at least one brake pad of the brake pad assembly.

The active backdrive assembly comprises: a floating ball ramp disposed against the rotatable part; a spring mechanism disposed against the floating ball ramp; and a retainer piece configured to hold the spring mechanism and the floating ball ramp against the rotatable part.

The retainer piece is held within a groove formed on a surface of the rotatable part.

The floating ball ramp and the rotatable part are each configured to include at least two inclined grooves.

The active backdrive assembly further comprises: backdrive means held in between the at least two inclined grooves of the floating ball ramp and the rotatable part, the backdrive means being ball-shaped.

The spring mechanism is configured to transition from an unloaded state to a loaded state and create an on-brake gap between the floating ball ramp and the rotatable part in response to actuation of the translatable part in a brake apply direction by the electric motor during a brake applying state of the EMB system.

The on-brake gap is larger than an off-brake gap between the floating ball ramp and the rotatable part when the EMB system is in an off-brake state.

The spring mechanism is configured to, while the EMB system is in the powerless state following the braking operation of the vehicle, revert back to the unloaded state and cause the translatable part to actuate in a brake release direction to revert the EMB system back to the off-brake state from the brake applying state.

According to some embodiments of the present disclosure, a motor vehicle may comprise: at least two road wheels; and at least one electromechanical braking (EMB) system attached to one of the at least two road wheels. The at least one EMB system may comprise: a brake rotor configured to be rotatable with a wheel of a vehicle; a brake pad assembly configured to be engageable with the brake rotor; an actuator assembly comprising an electric motor configured to actuate a translatable part and a rotatable part to mechanically move the brake pad assembly toward or away from the brake rotor; and an active backdrive assembly configured to release the at least one EMB system from an on-brake state to an off-brake state without using any electrical power when the at least one EMB system is in a powerless state following a braking operation of the vehicle.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 shows a cross-sectional view of a brake assembly according to one or more exemplary embodiments of the present disclosure.

FIG. 2A shows a cross-sectional view of an active backdrive assembly of the brake assembly of FIG. 1 according to one or more exemplary embodiments of the present disclosure.

FIGS. 2B-2G show components of the active backdrive assembly according to one or more exemplary embodiments of the present disclosure.

FIGS. 3A-3D show implementation examples of the active backdrive assembly according to one or more exemplary embodiments of the present disclosure.

FIG. 4 shows a schematic view of a vehicle including a steering system and a brake assembly according to one or more exemplary embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

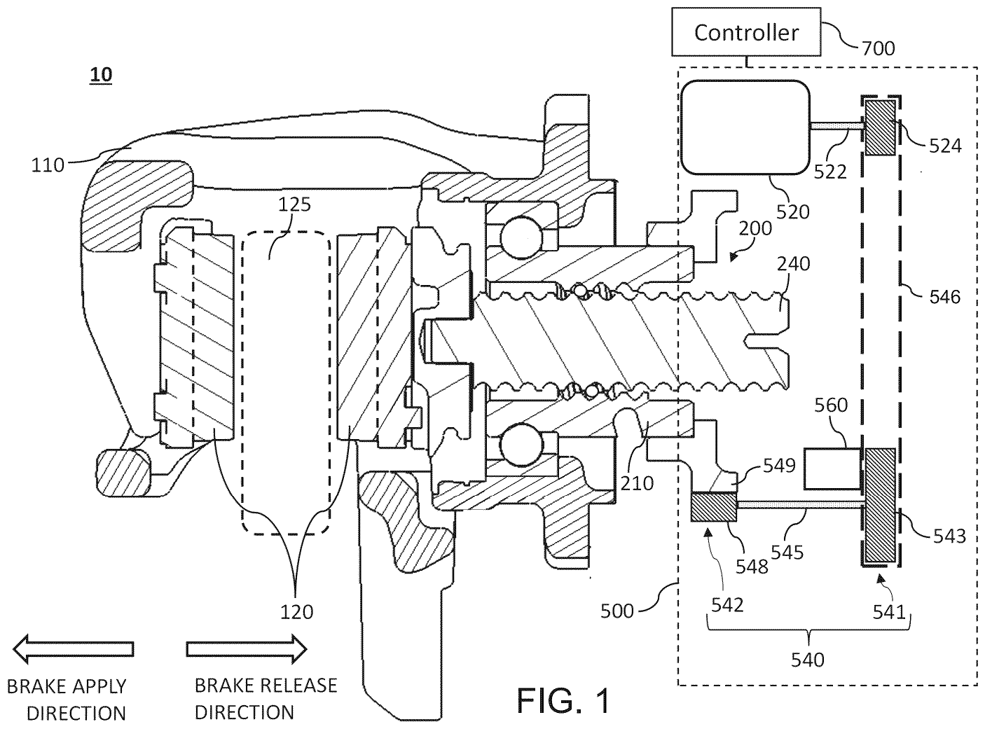

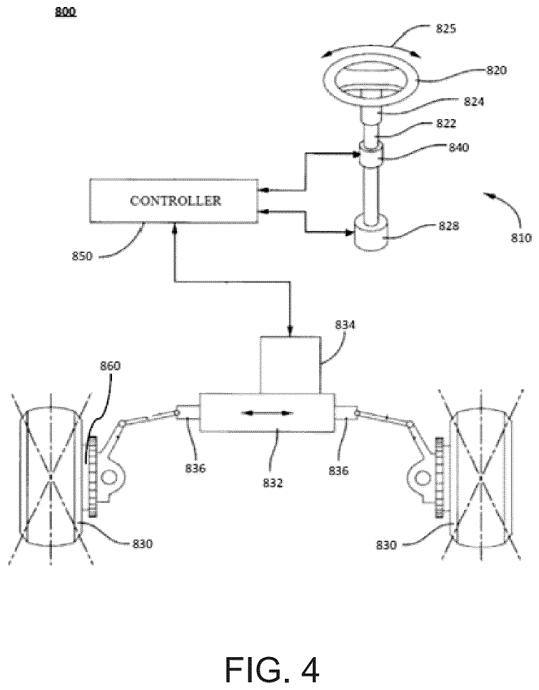

A vehicle (see, e.g., FIG. 4) may be equipped with one or more brake systems (e.g., an EMB system or the like) for slowing down or stopping rotation of a wheel of the vehicle (e.g., providing braking and stopping capabilities for vehicle). Such brake systems are usually controlled via electric power. In the event that power to these brake systems is lost (e.g., during mechanical and/or electrical failure of the brake systems and/or the vehicle), certain components of the brake systems that require electrical power to actuate may not be able to function. One particularly important component that may not function when there is a loss of power in these brake systems is an electrical motor (e.g., 520, FIG. 1) that mechanically moves brake pads of a brake pad assembly (e.g., 120, FIG. 1) toward and/or away from a brake rotor (e.g., 125, FIG. 1) in order to stop a rotation of a wheel of the vehicle. When the electrical motor loses function as a result of power loss in a brake system during braking operation of the vehicle, the brake pad assembly may also become stuck, which renders the brake system to be in a semi-permanent braking state (i.e., rendering one wheel of the vehicle to be in a continuously braking/locked state). Thus, a powerless (i.e., purely mechanical system) is required to free the brake system from such a semi-permanent braking state when the braking system experiences a loss of power (and/or other failures that may render the brake pad assembly to be continuously engaged with the brake rotor). Such unlocking of the brake system from the semi-permanent braking state may be achieved using the active backdrive assembly of embodiments disclosed herein.

Referring to FIG. 1, a brake assembly 10 may include a brake caliper 110 mounted in a floating manner by means of a brake carrier. When the vehicle is in motion, a brake rotor 125 may rotate with a wheel about an axle of the vehicle. A brake pad assembly (or brake lining assembly) 120 (e.g., an electromechanical brake (EMB) system, or the like) is provided in the brake caliper 110. The brake caliper 110 may include a bridge with fingers, and the fingers of the brake caliper 110 may be in contact with the brake pad assembly 120. Each brake pad of the brake pad assembly 120 is disposed with a small air clearance on a side of the brake rotor 125, such as a brake disc, in a release position so that no significant residual drag moment occurs.

The brake assembly 10 may comprise a screw mechanism 200 (e.g., a ball screw mechanism or a nut-screw mechanism) configured to convert rotary motion generated by an actuator assembly 500 into linear motion in order to move the brake pad assembly 120 (namely, the right brake pad of the brake pad assembly 120) toward or away from the brake rotor 125 in an axial direction. The screw mechanism 200 may include a rotatable part 210 and a translatable part 240. For example, the rotatable part 210 may comprise a nut or a ball nut and the translatable part 240 may comprise a screw or a ball screw, although not required. The rotatable part 210 is operably coupled to the actuator assembly 500 and is configured to be rotatable by actuation of the actuator assembly 500.

The actuator assembly 500 may comprises the electric motor 520. For example, the electric motor 520 may be directly engaged with the rotatable part 210. Alternatively, the electric motor 520 is indirectly connected to the rotatable part 210 through means for transferring rotary force generated by the electric motor 520, such as one or more gears, one or more belts, one or more pulleys, and/or any other connecting means and combination thereof.

The actuator assembly 500 may have a multi-stage drive mechanism 540, although not required. The multi-stage drive mechanism 540 may be, for example, but is not limited to, a dual-stage drive mechanism comprising a belt drive mechanism 541 and a gear drive mechanism 542 to multiply torque from the electric motor 520 to supply rotary force to the rotatable part 210 of the drive mechanism 540. The belt drive mechanism 541 multiplies the torque from the electric motor 520 by using a drive pully 524 and a driven pulley 543 rotatably connected by a drive belt 546, and the torque multiplied by the belt drive mechanism 541 is delivered to the gear drive mechanism 542 through the intermediate shaft 545. The intermediate shaft 545 may connect the driven pulley 543 of the belt drive mechanism 541 to a first gear 548 of the gear drive mechanism 542 in order to deliver rotary torque, generated by the electric motor 520 and transmitted through the belt drive mechanism 541, to the gear drive mechanism 542. The first gear 548 is rotatably engaged with the second gear 549 to rotate the second gear 549 by the rotary torque transmitted through the intermediate shaft 545. The second gear 549 may be formed directly on a part of the circumferential surface of a rotatable body or nut of rotatable part 210 of the drive mechanism 540 or screw mechanism 200 or be mounted to the rotatable body of rotatable part 210 of the drive mechanism 540 to rotate the rotatable body or nut of rotatable part 210.

The mechanical connection between the electric motor 520 and the brake pad assembly 120 described above and illustrated in FIG. 1 is an example for illustration purposes only, and the present disclosure is not limited thereto. Any structure, configuration, and arrangement of the mechanical connection that can mechanically connect the electric motor 520 to the brake pad assembly 120 can be used.

Because the electric motor 520 and the brake pad assembly 120 are mechanically connected to each other, the movement of the brake pad assembly 120 (namely, movement in the right brake pad of the brake pad assembly 120) can cause the electric motor 520 to move. For instance, if the brake pad assembly 120 moves, a rotor of the electric motor 520 (e.g., the motor shaft 522) can rotate. Accordingly, if the brake pad assembly 120 moves in the brake release direction after the parking brake 560 is applied, the displacement of the brake pad assembly 120 in the brake release direction can cause the rotor of the electric motor 520 (e.g., the motor shaft 522) to rotate due to the mechanical connection between the electric motor 520 and the brake pad assembly 120. As a result, a position of the electric motor 520 can be used to determine a linear position of the brake pad assembly 120, and vice versa.

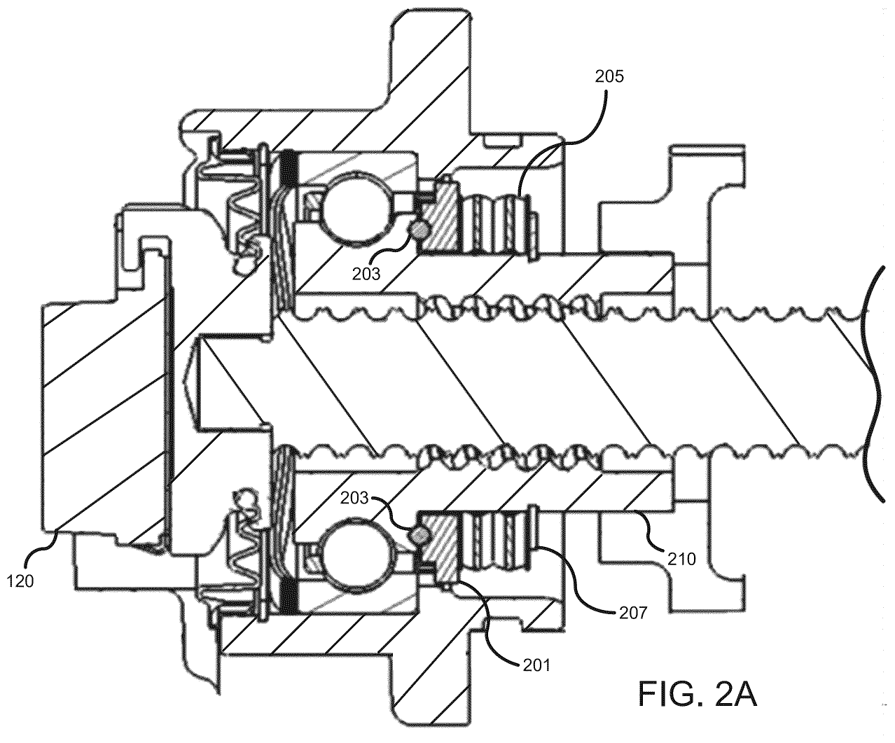

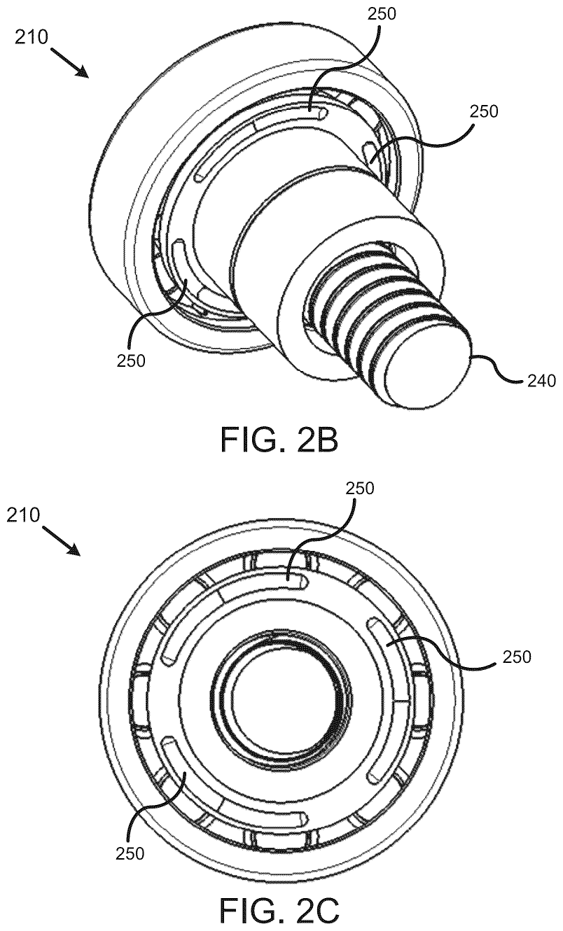

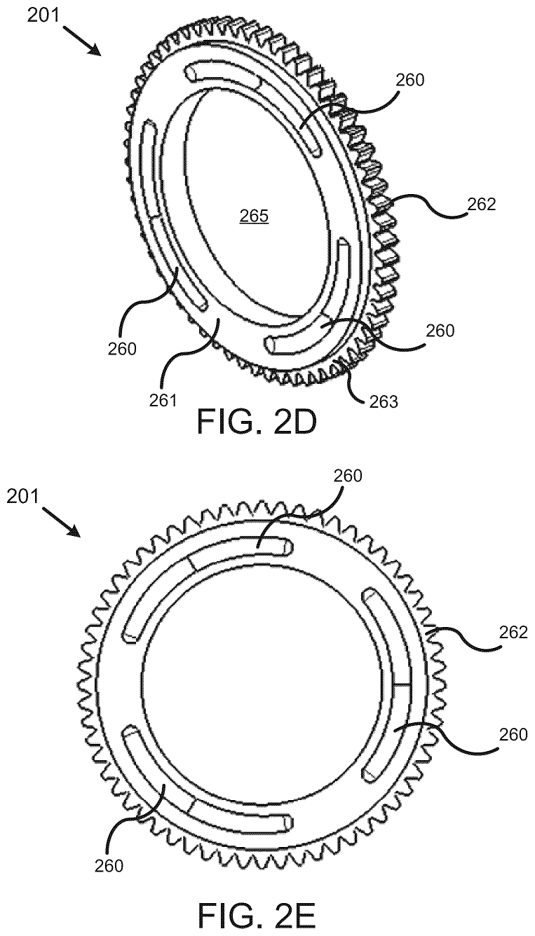

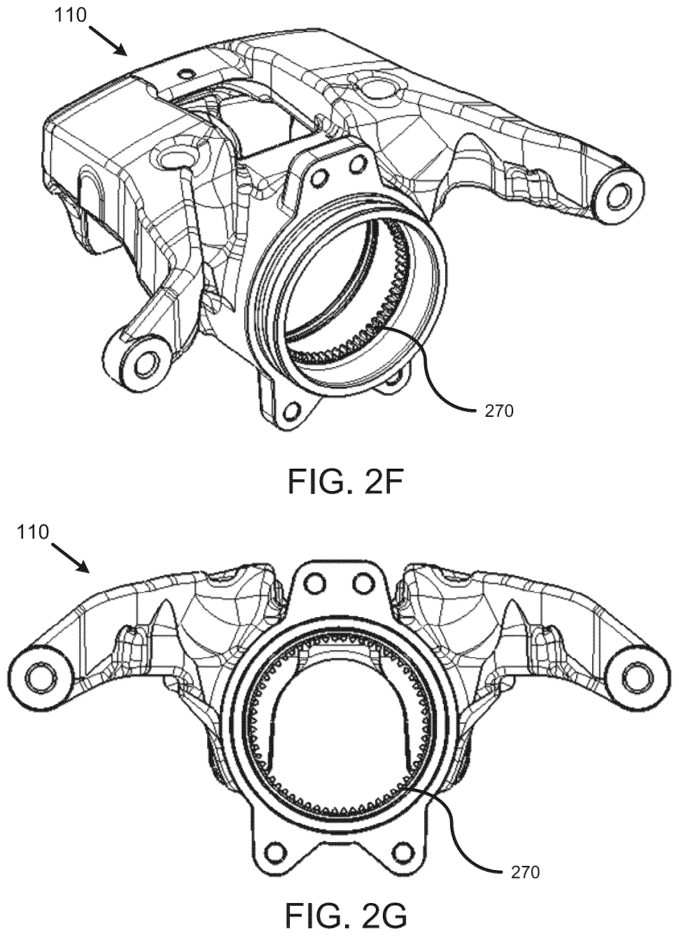

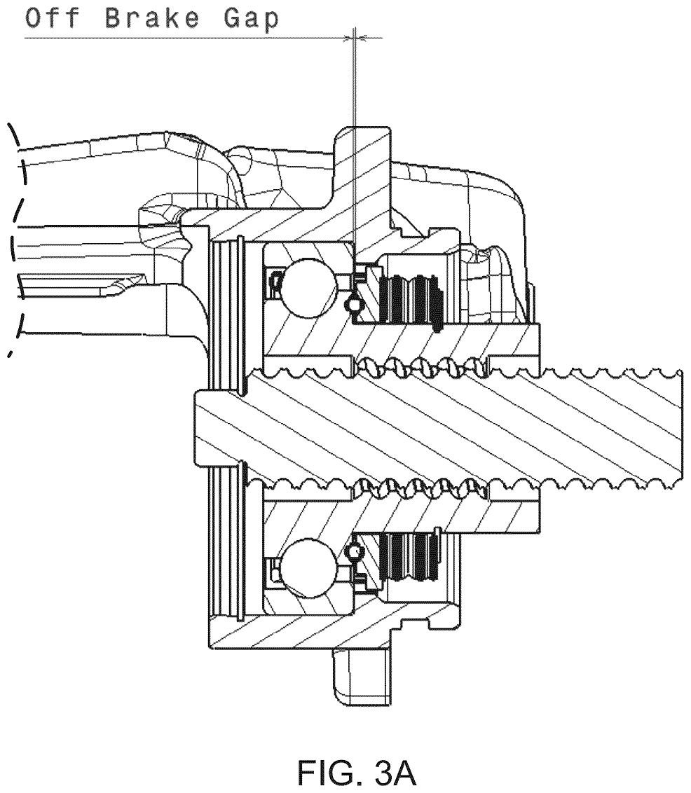

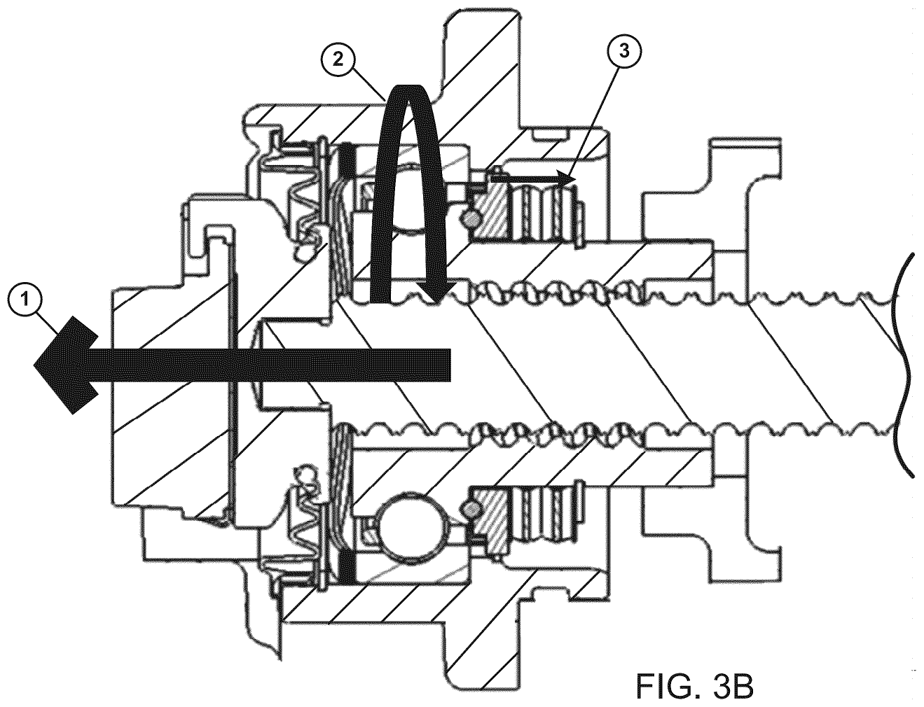

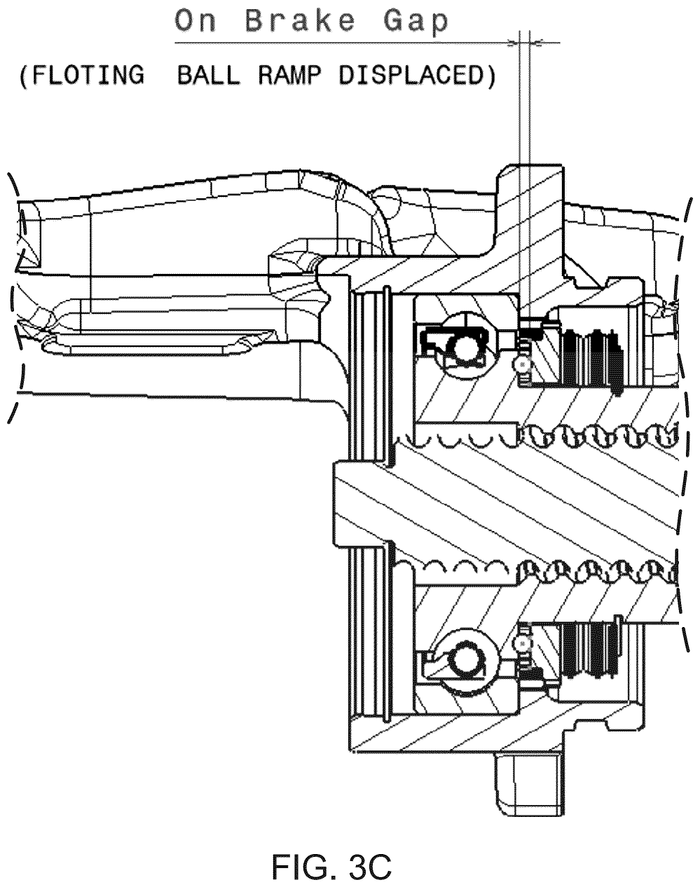

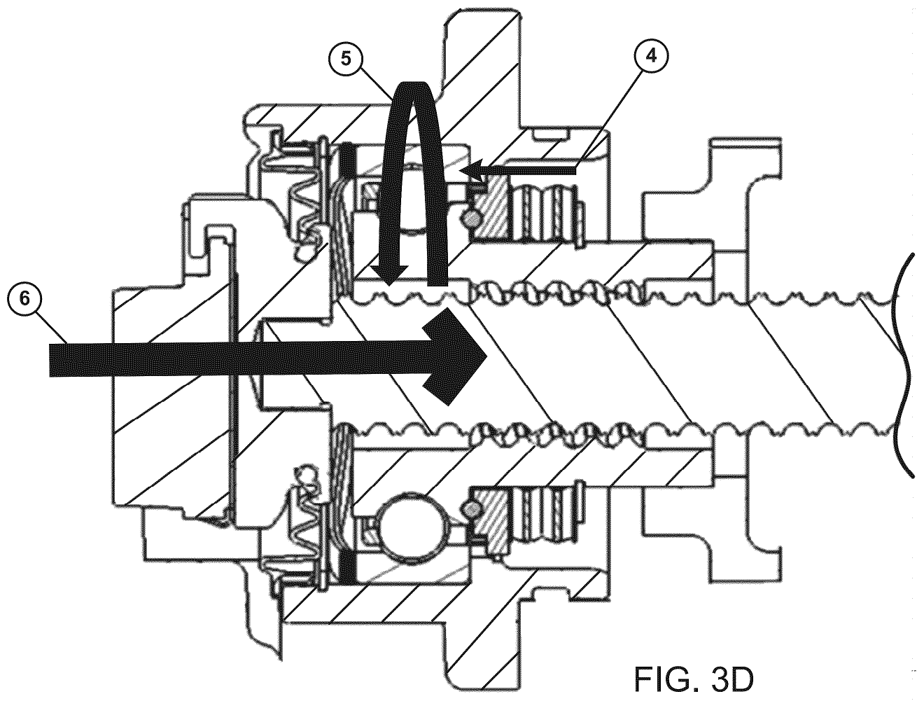

To detect such changes in the linear position of the brake pad assembly 120, brake assembly 10 may further include a controller 700 that is able to measure a movement and/or position of the electric motor 520 (e.g., via one or more sensors not shown in FIG. 1) and a torque (e.g., motor torque) generated by the electric motor 520. The controller 700 may also be configured to control the electric motor 520 to perform braking operations of the brake assembly 10 (e.g., the above discussed movement of the translatable part 240 to cause the brake pad assembly 120 to engage with the brake rotor 125). One example of the sensors configured to be installed within the brake assembly 10 may be the inductive position sensor of embodiments disclosed herein that is described in more detail in reference to FIGS. 2A-3B.

These one or more sensors may include any type and combination of sensors including, but not limited to: (i) force sensors, (ii) motor angle sensors; (iii) linear position sensors; (iv) temperature sensors; (v) current sensors; (iv) torque sensors; or the like. These one or more sensors may also be disposed (e.g., installed) within any portion of the brake assembly that is in proximity of the component or components that the sensors are configured to monitor and from which the sensors are configured to obtain measurements (e.g., obtain sensor readings from).

The controller 700 may also be configured to receive instructions (e.g., digital instructions) from a main computing system (e.g., via a serial connection bus such as a controller area network (CAN), bus or the like) of the vehicle to modify one or more parameters and/or capabilities of the brake assembly 10. The main computing system of the vehicle may be, for example, a chassis controller or the like.

The controller 700 may be, for example, but not limited to, a micro-controller unit (MCU), an electronic control unit (ECU), a circuit chip, a semiconductor circuit, and a circuit board having memory (e.g., for storing instructions to be executed by one or more processors coupled to the memory), one or more processors, and electric components. The controller 700 may be coupled to (e.g., one or more components of) the actuator assembly.

FIG. 2A shows a cross-sectional view of an active backdrive assembly of the brake assembly of FIG. 1 according to one or more exemplary embodiments of the present disclosure.

In embodiments, the active backdrive assembly may include a floating ball ramp 201, a spring mechanism 205, a retaining piece 207, backdrive means 203, and the rotatable part 210. Each of these components will be described in more detail below.

In embodiments, the spring mechanism 205 may include one or more springs. The retaining piece 207 may be a retainer nut, a washer, or the like that is configured to hold the floating ball ramp 201, the spring mechanism 205, and the backdrive means 203 against a surface of the rotatable part 210.

As shown in FIG. 2A, the retaining piece 207 may be inserted into a groove carved out on an outer surface of the rotatable part 210. However, embodiments disclosed herein are not limited to such a configuration and the retaining piece 207 may also be attached onto the rotatable part 210 using other mechanisms (e.g., welding, glue, friction from direct surface to surface contact, or the like) as long as the retaining piece 207 is able to secure the floating ball ramp 201, the spring mechanism 205, and the backdrive means 203 against the surface of the rotatable part 210 without causing movement of the retaining piece 207. Alternatively, the retaining piece 207 may be formed as a monolithic structure with the rotatable part 210 (e.g., as a protrusion on the surface of the rotatable part 210).

In embodiments, the backdrive means 203 may be ball-shaped components made of any suitable type of materials such as stainless steel, rubber, or the like. The backdrive means 203 may be inserted between the floating ball ramp 201 and the rotatable part 210 and cause the floating ball ramp to rotate with a rotation of the rotatable part 210, which will be discussed in more detail below in reference to FIGS. 2B and 2C

As shown in FIG. 2A, in embodiments, the floating ball ramp 201 may be in direct contact with a first surface of the rotatable part that is opposite to a second surface of the rotatable part that faces the brake pad assembly 120. One end of the spring mechanism 205 may be in direct contact with the floating ball ramp 201 while another end of the spring mechanism 205 may be in direct contact with the retaining piece 207. However, embodiments disclosed herein are not limited to this configuration and other components (e.g., stainless steel or rubber washers or the like) may be inserted in between any of these components.

Additionally, the floating ball ramp 201 and spring mechanism 205 may be installed to surround a tubular section of the rotatable part 210 through which the translatable part 240. In embodiments, the floating ball ramp 201 and spring mechanism 205 may be attached to the tubular section of the rotatable part 210 with a small air gap being present between these components such that the floating ball ramp 201 and spring mechanism 205 are able to actuate (e.g., in the brake apply and brake release directions as shown in FIG. 1) on the tubular section of the rotatable part 210 with little to no friction being generated between these components.

Turning now to FIGS. 2B and 2C, a perspective view of the rotatable part 210 is shown in FIG. 2B while a radial view of the rotatable part 210 is shown in FIG. 2C.

As shown in FIG. 2B, grooves 250 are carved into a surface of the rotatable part 210 that that faces away from the brake pad assembly 120 (i.e., the surface to be attached to floating ball ramp 201. Grooves 250 may be configured to include an inclined surface with one end of each of the grooves 250 being higher than the other end.

In embodiments, the rotatable part 210 be configured to include at least two of these grooves 250. These grooves 250 may also be configured to hold the backdrive means 203. In embodiments, the size of each of the grooves 250 (e.g., length, width, depth, etc.) may be set (e.g., predetermined) by a manufacturer of the brake assembly 10 based on the specifications and properties (e.g., shape, size, etc.) of the brake assembly 10.

Turning now to FIGS. 2D and 2E, a perspective view of the floating ball ramp 201 is shown in FIG. 2B while a radial view of the floating ball ramp 201 is shown in FIG. 2C.

As shown in FIGS. 2D and 2E, the floating ball ramp 201 may have a circular shape. Further, as shown in FIG. 2D and FIG. 2A, a first portion 261 of the floating ball ramp 201 that is configured to be engaged against (e.g., attached to) the rotatable part 210 may have a smaller circumference than a second portion 263 of the floating ball ramp 201.

The first portion 261 of the floating ball ramp 201 may have grooves 260 that are identical in shape, size, position, and number to the grooves 250 of the rotatable part 210. Essentially, the backdrive means 203 will be held in between grooves 260 of the floating ball ramp 201 and grooves 250 of the rotatable part 210. However, the inclined surfaces of the grooves 250 and 260 may be positioned opposite to one another (i.e., the top-most surface of the grooves 250 may face the bottom-most surface of the grooves 260, or vice versa.

The second portion 263 may include gear teeth 262 (or other similar mechanical structures) that are able to retain and stabilize (namely, a horizontal movement of) the floating ball ramp 201 within the brake assembly 10. As shown in FIGS. 2F and 2G (showing perspective and radial views of a housing of the brake caliper 110, respectively), these gear teeth 262 may be configured to engage with corresponding gear teeth 270 that are formed on an internal surface of the housing of brake caliper 110.

As also shown in FIG. 2E, the floating ball ramp 201 may also have an opening for the floating ball ramp 201 to be inserted onto the tubular section of the rotatable part 210. In embodiments, the floating ball ramp 201 may be made of rubber, stainless steel, or the like.

In embodiments, the shape, size, and other properties (e.g., material) of the floating ball ramp 201 are not limited to those discussed above and may be modified (e.g., by a manufacturer of the brake assembly 10) based on the specifications and properties of the brake assembly 10 as a whole. In embodiments, only the floating ball ramp 201 may be configured to include the grooves 260 while the rotatable part 210 is configured without the grooves 250.

Turning now to FIGS. 3A-3D, implementation examples of the active backdrive assembly according to one or more exemplary embodiments of the present disclosure are provided. All of the reference numbers shown in FIGS. 1 through 2G are applicable in the same manner to FIGS. 3A-3D.

Starting with FIG. 3A, FIG. 3A shows a state of the brake assembly 10 when no braking operations are being performed (also referred to herein as an “off-brake state of the braking assembly 10”). During this off-brake state, a gap (e.g., off-brake gap shown in FIG. 3A) may exist between the floating ball ramp 201 and the rotatable part 210. This off-brake gap may be small (e.g., under 1 mm or less) or non-existent.

Turning now to FIG. 3B, assume that the brake assembly 10 has been caused to perform a braking operation and is now in a braking apply state (also referred to herein as an “on-brake state”). The circled numbers shown in FIG. 3B represent different points in time during this braking apply state.

At a first point in time (1), the translatable part 240 is moved (e.g., rotated) by electric motor 520 in the brake apply direction to push the brake pad assembly 120 against the brake rotor 125. Such rotation of the translatable part 240 also causes (at the second point in time (2)) the rotatable part 210 to rotate.

This rotation in the rotatable part 210 also cause the floating ball ramp 201 to rotate (namely, through movement of the backdrive means 203 within the grooves 250 and 260 of the rotatable part 210 also cause the floating ball ramp 201, respectively. Because of the inclined structure of these grooves 250 and 260, as the backdrive means 203 are rotated toward a top-most surface of these inclined grooves 250 and 260, the floating ball ramp 201 is pushed backward (i.e., in the brake release direction) at the third point in time (3).

When the floating ball ramp 201 is pushed backward at the third point in time, the spring mechanism 205 is engaged by this backward movement of the floating ball ramp 201 and the spring mechanism 205 is placed into a loaded state as the floating ball ramp 201 pushes the spring mechanism 205 against the retaining piece 207.

As a result of the movement caused at the second (2) and third (3) point in time of FIG. 3B, an on-brake gap is now formed (i.e., where the off-brake gap existed) between the rotatable part 210 and the floating ball ramp 201 as shown in FIG. 3C.

Turning now to FIG. 3D, assume now that the electric motor 520 has stopped actuating and there is no force being applied on the translatable part 240 to push (e.g., actuate, rotate, or the like) the translatable part 240 toward the brake apply direction. Further assume that this point in time in FIG. 3D that the brake assembly 10 has malfunctioned and lost power such that the electric motor 520 is unable to rotate in the reverse direction to pull the translatable part 240 back in the brake release direction.

Without requiring any electrical power being supplied to the brake assembly 10 and without requiring assistance from electric motor 520, the active backdrive assembly may advantageously release the brake pad assembly 120 from engaging with the brake rotor 125. In particular, as shown in FIG. 3D, at the fourth point in time (4), the spring mechanism 205 that was just now in the loaded state springs back (e.g., through the natural spring force of the spring(s) making up the spring mechanism 205) to return to the original unloaded state, which causes the floating ball ramp 201 to be pushed back and rotate toward the brake apply direction. Essentially, the floating ball ramp 201 is pushed back toward the rotatable part 210 such that the on-brake gap shown in FIG. 3C returns to the off-brake gap state shown in FIG. 3A.

This movement of the floating ball ramp 201 caused by the spring mechanism 205 causes the rotatable part 210 to rotate in the reverse direction (i.e., the reverse direction of which the rotatable part 210 was rotating at the second point in time (2) of FIG. 3B) at a fifth point in time (5). This rotation of the rotatable part 210 at the fifth point in time (5) is again caused by the movement (e.g., rotation) of the backdrive means 203 within the grooves 250 and 260.

As the rotatable part 210 is caused to rotate in the reverse direction, the translatable part 240 is caused to rotate (i.e., within the rotatable part 210 and at the sixth point in time (6)) in the brake release direction, causing the brake pad assembly 120 to be pulled back and disengage from the brake rotor 125.

As a result, the brake assembly 10 that is in the powerless (e.g., power loss, or the like) state may be released from the brake applying state without the use of any electrical power and/or any components that require electrical power to function. Said another way, the active backdrive assembly of embodiments disclosed herein is advantageously configured to be able to release the power loss state brake assembly 10 from being locked in a braking apply state back to the off-brake state.

Any vehicle according to certain exemplary embodiments of the present disclosure may be identical, or substantially similar to, vehicle 800 shown in FIG. 4. The vehicle 800 may be any passenger or commercial automobile such as a hybrid vehicle, an electric vehicle, or any other type vehicles. FIG. 4 is a schematic view of a vehicle 800 including a steering system and a brake assembly 860 (e.g., the brake assembly 10 discussed above in reference to FIG. 1) according to an exemplary embodiment of the present disclosure. The vehicle 800 may include a steering system 810 for use in a vehicle. The steering system 810 can allow a driver or operator of the vehicle 800 to control the direction of the vehicle 800 or road wheels 830 of the vehicle 800 through the manipulation of a steering wheel 820. The steering wheel 820 is operatively coupled to a steering shaft (or steering column) 822. The steering wheel 820 may be directly or indirectly connected with the steering shaft 822. For example, the steering wheel 820 may be connected to the steering shaft 822 through a gear, a shaft, a belt and/or any connection means. The steering shaft 822 may be installed in a housing 824 such that the steering shaft 822 is rotatable within the housing 824.

The road wheels 830 may be connected to knuckles, which are in turn connected to tie rods. The tie rods are connected to a steering assembly 832. The steering assembly 832 may include a steering actuator motor 834 and steering rods 836. The steering rods 836 may be operatively coupled to the steering actuator motor 834 such that the steering actuator motor 834 is adapted to move the steering rods 836. The movement of the steering rods 836 controls the direction of the road wheels 830 through the knuckles and tie rods.

One or more sensors 840 may be configured to detect position, angular displacement or travel 825 of the steering shaft 822 or steering wheel 820, as well as detecting the torque of the angular displacement. The sensors 840 provide electric signals to a controller 850 indicative of the angular displacement and torque 825. The controller 850 sends and/or receives signals to/from the steering actuator motor 834 to actuate the steering actuator motor 834 in response to the angular displacement 825 of the steering wheel 820.

In the steer-by-wire steering system, the steering wheel 820 may be mechanically isolated from the road wheels 830. For example, the steer-by-wire system has no mechanical link connecting the steering wheel 825 from the road wheels 830. Accordingly, the steer-by wire steering system may comprise a feedback actuator or steering feel actuator 828 comprising an electric motor which is connected to the steering shaft or steering column 822. The feedback actuator or steering feel actuator 828 provides the driver or operator with the same “road feel” that the driver receives with a direct mechanical link.

Although the embodiment illustrated in FIG. 4 shows the vehicle 800 having the steer-by-wire steering system, the vehicle 800 may alternatively have a mechanical steering system without departing from embodiments disclosed herein. The mechanical steering system typically includes a mechanical linkage or a mechanical connection between the steering wheel 820 and the road wheels 830. In the mechanical steering system, the steering actuator motor 834 includes an electric motor to provide power to assist the movement of the road wheels 830 in response to the operation of the driver or a control signal of the controller 850. Accordingly, the electric motor can be used as the steering actuator motor 834 or can be included in the feedback actuator or steering feel actuator 828.

Although the example embodiments have been described in detail, it should be understood that various changes, substitutions and alterations can be made herein without departing from the spirit and scope of the present disclosure as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An electromechanical brake (EMB) system comprising:
a brake rotor configured to be rotatable with a wheel of a vehicle;
a brake pad assembly configured to be engageable with the brake rotor;
an actuator assembly comprising an electric motor configured to actuate a translatable part and a rotatable part to mechanically move the brake pad assembly toward or away from the brake rotor; and
an active backdrive assembly configured to release the EMB system from an on-brake state to an off-brake state without using any electrical power when the EMB system is in a powerless state following a braking operation of the vehicle.

2. The EMB system of claim 1, wherein the translatable part is inserted through and partially surrounded by the rotatable part, and the active backdrive assembly is disposed on the rotatable part.

3. The EMB system of claim 2, wherein the translatable part is attached to at least one brake pad of the brake pad assembly.

4. The EMB system of claim 3, wherein the active backdrive assembly comprises:
a floating ball ramp disposed against the rotatable part;
a spring mechanism disposed against the floating ball ramp; and
a retainer piece configured to hold the spring mechanism and the floating ball ramp against the rotatable part.

5. The EMB system of claim 4, wherein the retainer piece is held within a groove formed on a surface of the rotatable part.

6. The EMB system of claim 4, wherein the floating ball ramp and the rotatable part are each configured to include at least two inclined grooves.

7. The EMB system of claim 6, wherein the active backdrive assembly further comprises:
a plurality of ball-shaped components inserted between the at least two inclined grooves of the floating ball ramp and the at least two inclined grooves of the rotatable part.

8. The EMB system of claim 4, wherein the spring mechanism is configured to transition from an unloaded state to a loaded state and create an on-brake gap between the floating ball ramp and the rotatable part in response to actuation of the translatable part in a brake apply direction by the electric motor during a brake applying state of the EMB system.

9. The EMB system of claim 8, wherein the on-brake gap is larger than an off-brake gap between the floating ball ramp and the rotatable part when the EMB system is in an off-brake state.

10. The EMB system of claim 9, wherein the spring mechanism is configured to, while the EMB system is in the powerless state following the braking operation of the vehicle, revert back to the unloaded state and cause the translatable part to actuate in a brake release direction to revert the EMB system back to the off-brake state from the brake applying state.

11. A vehicle comprising:
at least two road wheels; and
at least one electromechanical braking (EMB) system attached to one of the at least two road wheels, wherein the at least one EMB system comprises:
a brake rotor configured to be rotatable with a wheel of a vehicle;
a brake pad assembly configured to be engageable with the brake rotor;
an actuator assembly comprising an electric motor configured to actuate a translatable part and a rotatable part to mechanically move the brake pad assembly toward or away from the brake rotor; and
an active backdrive assembly configured to release the at least one EMB system from an on-brake state to an off-brake state without using any electrical power when the at least one EMB system is in a powerless state following a braking operation of the vehicle.

12. The vehicle of claim 11, wherein the translatable part is inserted through and partially surrounded by the rotatable part, and the active backdrive assembly is disposed on the rotatable part.

13. The vehicle of claim 12, wherein the translatable part is attached to at least one brake pad of the brake pad assembly.

14. The vehicle of claim 13, wherein the active backdrive assembly comprises:
a floating ball ramp disposed against the rotatable part;
a spring mechanism disposed against the floating ball ramp; and
a retainer piece configured to hold the spring mechanism and the floating ball ramp against the rotatable part.

15. The vehicle of claim 14, wherein the retainer piece is held within a groove formed on a surface of the rotatable part.

16. The vehicle of claim 14, wherein the floating ball ramp and the rotatable part are each configured to include at least two inclined grooves.

17. The vehicle of claim 16, wherein the active backdrive assembly further comprises:
a plurality of ball-shaped components inserted between the at least two inclined grooves of the floating ball ramp and the at least two inclined grooves of the rotatable part.

18. The vehicle of claim 14, wherein the spring mechanism is configured to transition from an unloaded state to a loaded state and create an on-brake gap between the floating ball ramp and the rotatable part in response to actuation of the translatable part in a brake apply direction by the electric motor during a brake applying state of the at least one EMB system.

19. The vehicle of claim 18, wherein the on-brake gap is larger than an off-brake gap between the floating ball ramp and the rotatable part when the at least one EMB system is in an off-brake state.

20. The vehicle of claim 19, wherein the spring mechanism is configured to, while the at least one EMB system is in the powerless state following the braking operation of the vehicle, revert back to the unloaded state and cause the translatable part to actuate in a brake release direction to revert the at least one EMB system back to the off-brake state from the brake applying state.
